(19) United States
(12) Patent Application Publication
(10) Pub. No.: US 2012/0271773 A1
(43) Pub. Date: Oct. 25, 2012

(54) Counterfeit Products Detection Methods and System

(76) Inventor: Kenneth H. Pieri, Grand Island, NY (US)

(21) Appl. No.: 13/450,659

(22) Filed: Apr. 19, 2012

Related U.S. Application Data
(60) Provisional application No. 61/476,987, filed on Apr. 19, 2011.

(51) Int. Cl. G06Q 99/00

(52) U.S. Cl. 705/318

(57) ABSTRACT

A counterfeit product detection method and system for detecting whether a product is genuine or counterfeit. The method allows a consumer to check whether a product is authentic or counterfeit by way of using a sequential serial number assigned to the particular product by the manufacturer of the product. Alternatively, the authenticity of the product can be verified at the point of purchase at the retailer or over the telephone by way of the sequential serial number. The method provides a way for a manufacturer's recall to reach the consumers who purchase the product.

### CROSS REFERENCE TO RELATED APPLICATION

This application claims priority to U.S. Provisional Application having Ser. No. 61/476,987, filed on Apr. 19, 2011 the entire disclosure of which is hereby incorporated herein by reference.

### BACKGROUND OF INVENTION

The speed and ease at which products can be quickly manufactured and subsequently shipped around the world is remarkable. In this respect the world is becoming a smaller place. Unfortunately, this also facilitates the counterfeiting of goods and products by an increasing number of counterfeiters. These counterfeiters are becoming more and more savvy at counterfeiting. Counterfeit goods have also long been a source of problems and concerns in the industries of clothing, accessories, wrist watches, hand bags, suitcases, movies, music recordings, et cetera. One of the serious problems associated with counterfeited products is that they look and feel the same as the authentic products, and have matching colors, sizes, but, weights and markings that are exactly the same as the authentic products, but are not genuine. In addition, the counterfeited products have external and internal packaging that is exactly the same as the authentic product packaging. One of the main problems with these products is that the consumer and the manufacturer are badly cheated. Both suffer loses. The consumer receives poor quality, which in many cases, causes a shortened life of the product and the manufacturer loses profits.

In addition, there is usually an enormous difference in the price between the counterfeited product and the authentic product. Thus, it is quite possible that the counterfeiter makes more money on the counterfeited product, than the legitimate manufacturer makes on its own product. This fact alone provides counterfeiters with an enormous incentive to copy various products, along with the packaging.

Another problem with some counterfeited products is that, depending on the product, it could be very dangerous and unsafe for consumers, such as a fire extinguisher or smoke alarm products.

What is needed is a way to stave off the serious dangers of these counterfeit products. It would also be desirable to have a simple method for the consumer to determine whether or not the product is genuine or counterfeit. It would also be desirable for the method to be easy to use and relatively inexpensive for the consumer to verify whether or not a particular product is or is not counterfeit.

### SUMMARY OF THE INVENTION

The counterfeit detection method provides a way for consumers to verify whether a product is genuine or counterfeit. This is accomplished by having the manufacturer attach a unique, sequential serial number for each unit of production, such as for each handbag, wristwatch or even a pair of pants. This invention could be utilized for thousands of consumer products.

The process entails the consumer obtaining a “permanent” personal identification (ID) number similar to a Social Security number. For example, the personal ID is nine digits or combination of letters and numbers obtained from a national registry office. The personal ID serves as a positive identification of the purchasing consumer.

Although a personal ID number should be used when contacting the manufacturer of a product, it would not be required unless the consumer would like to also register with the manufacturer for warranty purposes, especially in the case of a defect with the product, (at a later date), a “Recall” by the manufacturer or the theft and possible recovery of the product. Each product would have a sequential serial number sewn into it, embossed on it, laser marked (such as in the case of a wrist watch) in it, or attached in some manner. Many products such as televisions, cell phones, computers, et cetera already have serial numbers.

### Computer Verification Method (FIG. 1)

In one of the preferred embodiments, the consumer requests that the retailer go to the manufacturer's website and enter the manufacturer's identification number and the sequential serial number of the product before he or she purchases the product. In the case of the retail store conducting the confirmation, the store would present the manufacturer's email reply to the consumer. Alternatively the consumer purchases the product and uses his or her own computer to obtain an authentication of the product via email from the manufacturer.

### Telephone Verification Method (FIG. 2)

In another preferred embodiment, the consumer may elect to call a toll free number (provided by the product manufacturer) and directly contact the product manufacturer and obtain verbal approval or rejection of the legitimacy of the product.

### Manufacturer's Recall System

In the event of a manufacturer's “recall”, the serial numbered system would allow the manufacturer to locate and/or contact the consumer and assist with the problem.

### BRIEF DESCRIPTION OF THE DRAWING FIGURES

FIG. 1 is a flow chart showing a first embodiment of the counterfeit product detection method wherein the authenticity of a product is verified via computer verification.

FIG. 2 is a flow chart showing a second embodiment wherein the authenticity of a product is verified by via telephonic verification.

### DESCRIPTION

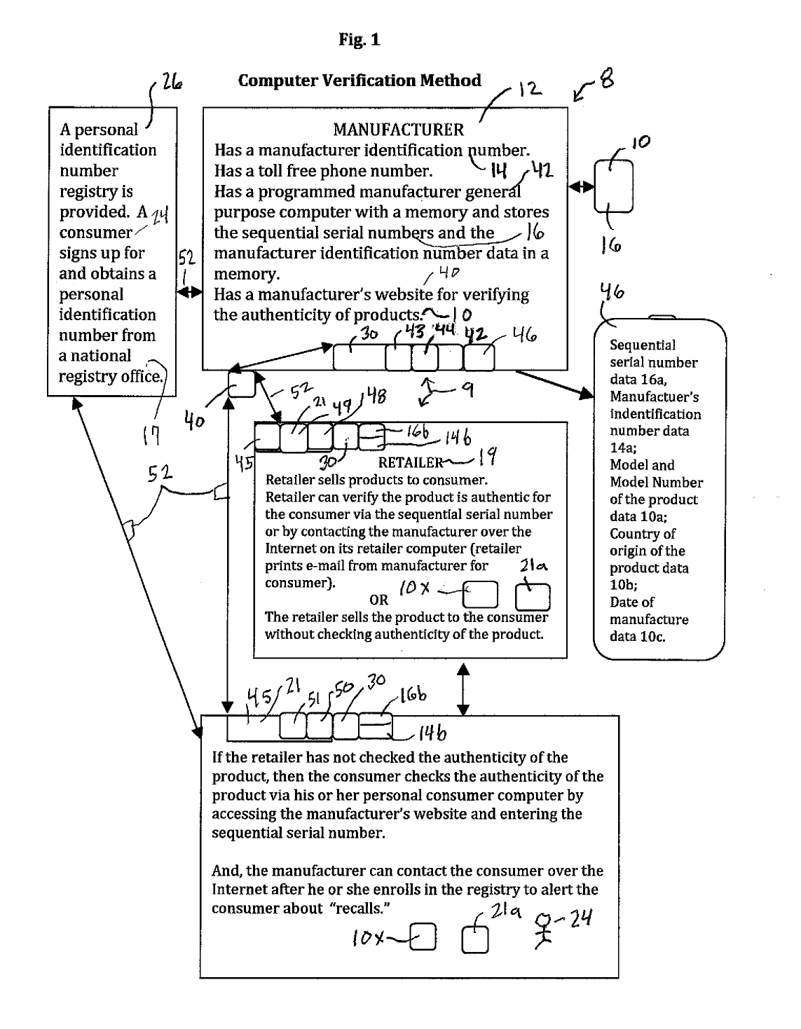

### Computer Verification (FIG. 1)

FIG. 1 is flow chart showing a method for detecting counterfeit products 8. As shown, the method begins with the manufacturer 12 of product 10. The manufacturer 12 has its own manufacturer identification number 14. The manufacturer 12 assigns a unique sequential serial number 16 to each product 10 that it manufactures. These products 10 are authentic or non-counterfeit. For example, if the products 10 made by the manufacturer are wristwatches, then the manufacturer 12 will assign to each wristwatch its own unique sequential serial number 16. The manufacturer identification number 14 and the sequential serial number 16 can include letters, numerals and combinations of letters and numerals.

In one of the preferred embodiments the sequential serial number 16 and the manufacturer identification number 14 are each created in such a manner that they do not include the letters B, C, D, E, M, N, P, T, V, Z. The reason for this is that these letters may lead to confusion when they are pronounced because they may sound like a different letter.

For each product 10 made by the manufacturer 12 the following information or data pertaining to the product 10 will be created and saved or stored by the manufacturer 12

a) the sequential serial number 16 assigned to that product 10 (sequential serial number data 16a);

b) the manufacturer's identification number 14 (manufacture's identification number data 14a);

c) the model and model number of the product 10 (model and model number of the product data 10a);

d) the country of origin of the product 10 (country of origin product data 10b);

g) the date of manufacture of the product 10 (date of manufacture data 10c)

e) the website address for the manufacturer 12; and,

f) the toll free number of the manufacturer 12.

Prior to making a purchase the consumer 24 should first obtain a “permanent” personal identification (ID) number 26 similar to a Social Security number with, for example, 9 digits or a combination of letters and numbers, from a national registry office 17 set up for the purpose of providing personal identification (ID) numbers 26 to consumers 24. The consumer 24 can call the national registry office 17 to obtain the personal identification number 26. The personal identification number 26 serves as positive identification of the purchasing consumer 24. The personal identification number 26 is, in one of the preferred embodiments, created so as not to include the letters B, C, D, E, M, N, P, T, V, Z for the reasons described above. The consumer 24 can call the national registry 17 and obtain a personal identification number 26 in one of the preferred embodiments.

When the manufacturer 12 manufactures the product it attaches the sequential serial number 16 to the product 10. This may be accomplished in a plurality of ways. For example, the manufacturer 12 can laser etch the sequential serial number 16 directly on a surface of the product 10, or can stamp the sequential serial number 16 into or onto the product 10, or can sew a tag having the sequential serial number 16 to the product 10, or can attach to the product 10 a sequential serial number 16 with a sticker (if for example the product is formed from plastic or glass), et cetera.

After shopping at a retailer 19, the consumer 24 goes to the checkout counter with a product 10x, but the authenticity of the product 10x is unknown, that is it could be authentic or counterfeit. At the point of sale the consumer 24 has two options.

As a first option, the consumer 24 can request the retailer 19 (or a clerk working for the retailer 19) to access or log onto the website 40 of the manufacturer 12 and enter the manufacturer's identification number 14 and the sequential serial number 16. In particular, the retailer 19 uses its own retailer computer 48 to access the website 40 of the manufacturer 12 and inputs the sequential serial number 16 and the manufacturer's identification number 14. The retailer 19 will then be able to provide an immediate verification as to whether the product 10x is or is not an authentic product 10 as soon as the retailer 19 receives a response back from the manufacturer 12. In one of the preferred embodiments the response from the manufacturer 12 is in the form of an email 21 sent from the manufacturer 12 to the retailer 19. The retailer 19 can read the email 21 on a retailer computer screen display 49 that is used in connection with the retailer computer 48. The retailer 19 can then print the email 21 and provide the consumer 24 with a printed email 21a indicating whether the product 10x is or is not an authentic product 10.

Alternatively, the consumer 24 purchases the product 10x from the retailer 19, goes home, and uses his or her own personal consumer computer 50 to access the website 40 of the manufacturer 12. The consumer 24 then inputs the sequential serial number 16. The manufacturer 12 sends an email 21 to the consumer 24 indicating whether or not the product 10x is or is not an authentic product 10. The consumer 24 reads the email 21 on his or her personal consumer computer screen display 51. If the email 21 indicates that the product 10x is counterfeit, then the consumer 24 can return to the retailer 19, present the printed email 21a that he or she printed and obtain a refund for the purchase price of the product 10x.

There is also a system 9 provided for carry out the method for detecting counterfeit products 8. The system 9 includes a programmed manufacturer general purpose computer 42 having a central processing unit 44 and a memory component 46 that is owned by the manufacturer 12. The memory component 46 is for storing data pertaining to the authentic or non-counterfeited product 10 including at least the following data:

sequential serial number data 16a,

the manufacture's identification number data 14a;

model and model number of the product data 10a;

the country of origin of the product data 10b; and,

the date of manufacture data 10c.

The memory component 46 is a standard memory component, the use and operation of which are well known to those having ordinary skill in the art and are therefore is not described in greater detail herein.

The central processing unit 44 uses and processes sequential serial number data 16a, the manufacture's identification number data 14a; model and model number of the product data 10a; the country of origin of the product data 10b; and, the date of manufacture data 10c pertaining to the authentic product 10.

The central processing unit 44 is capable of generating outputs 45.

The central processing unit 44 also uses and processes the sequential serial number data 16b and manufacturer identification number data 14b inputted (by the consumer 14 or retailer 19) pertaining to the potentially counterfeited product 10x for which the authenticity is in question, and compares the sequential serial number data 16a and manufacturer identification number data 14a of the authentic product 10 with the sequential serial number 16b and the manufacturer identification number data 14b of the product 10x purchased, and creates an output 45 indicating whether or not the product 10x is or is not counterfeit. The outputs 45 can be screen display content that is displayed on a consumer computer screen display 51, the retail computer screen display 49, a manufacturer screen display 43 and the website 40 operated by the manufacturer 12. The outputs 45 on the screen display of the consumer computer screen display 51, the retail computer screen display 49, a manufacturer screen display 43 and the website 40 operated by the manufacturer 12 can be in the form of a message as to whether or not the product 10x is or is not authentic (or counterfeit). The output 45 can also be in the form of the previously described emails 21 that are to be sent to the retailer computer 48 and the personal consumer computer 50 and then printed out as printed emails 21a. The above-described screen displays may be embodied as other graphical user interfaces known to those having ordinary skill in the art. Central processing units and their use and operation are well known to those having ordinary skill in the art and are therefore not described in greater detail herein.

In addition, the act of programming a computer, for example the programmed manufacturer general purpose computer 42, to execute instructions in order to carry out the functions described above is well known to those having ordinary skill in the art and is therefore not described in greater detail herein.

There is also an interface component 30 associated with the programmed manufacturer general purpose computer 42 to allow access to the Internet 52. The use and operation of the Internet 52 is well known to those having ordinary skill in the art and is therefore not described in greater detail herein.

In particular, the retailer computer 48 and personal consumer computer 50 (that also have interface components commonly designated 30) are in communication with the programmed manufacture general purpose computer 42 by way of interface components 30. The interface components 30 are capable of transmitting and allowing for the flow incoming and outgoing above-described data, and emails 21 between the programmed general purpose computer 42 and the retailer computer 48 and the personal consumer computer 50. The interface components 30 are also for allowing graphical presentations to be viewed on the consumer computer screen display 51 and the retailer computer screen display 49. Interface components 30 are well known to those having ordinary skill in the art and include any combination of hardware, firmware, or software in a computer used to enable communication or data transfer between the computer and a device, system, or network external to the computer. And, the interface components 30 can connect with a system, or network external to the programmed manufacturer general purpose computer 42, using, for example, a hardwire connection, an optical connection, an Internet connection, or a radio frequency connection, and all of these types of connections are well known to those having ordinary skill in the art.

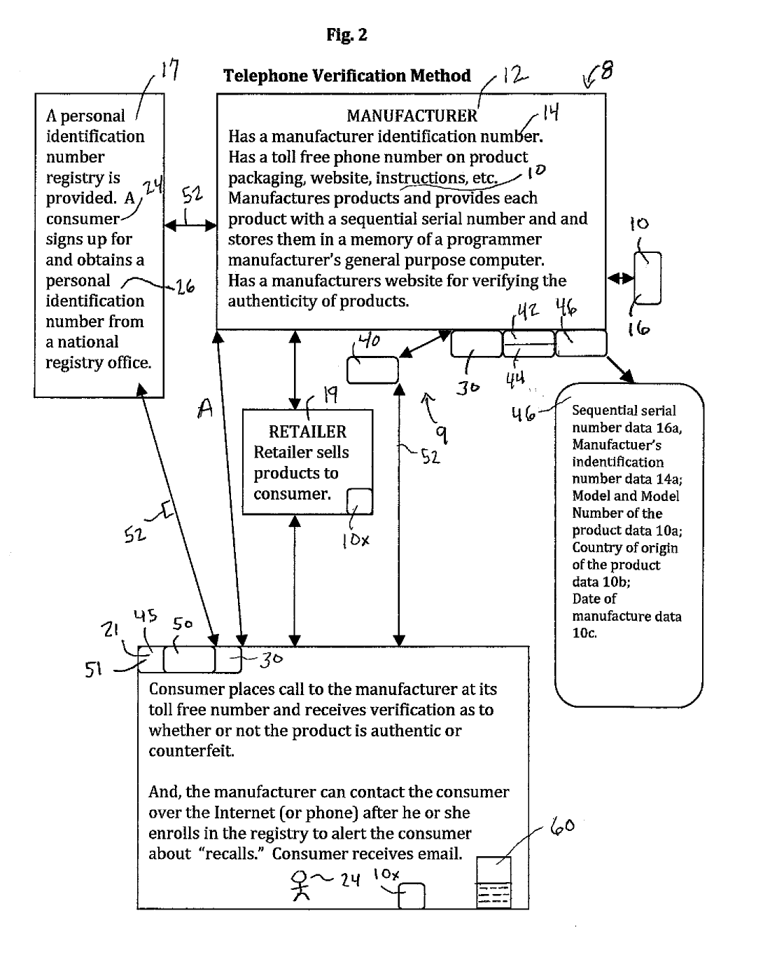

### Telephone Verification Method (FIG. 2)

In another preferred embodiment of the method for detecting counterfeit products 8 is shown in FIG. 2. The consumer 24 purchases the product 10x and then places a call to the manufacturer's 12 toll free number over his or her phone 60 (indicated by the arrow designated A in FIG. 2). The manufacturer 12 provides the toll free number on its product packaging, in the product instructions or on its website 40. The consumer 24 provides the sequential serial number 16 over the phone 60 to the manufacturer 12, and the manufacturer 12 informs the consumer 24 as to whether or not the product 10x is or is not an authentic product 10.

### Manufacturer's Recall System

As shown in FIGS. 1 and 2, prior to making a purchase the consumer 24 has the option of first obtaining a “permanent” personal identification (ID) number 26 from the national registry office 17. The consumer 24 may call the phone number of the registry office 17, or may register over the Internet 52. The personal ID number 26 can then be used when contacting the manufacturer 12 of the authentic product 10. The personal identification number 26 would not be required unless the consumer would like to also register with the manufacturer 12 for warranty purposes, especially in the case of a defect with the product 10, (at a later date), a “Recall” by the manufacturer 12 or the theft and possible recovery of the product 10.

In the event of a product 10 “recall” by the manufacturer 12, the sequential serial number 16 in combination with the personal identification number 26 would allow the manufacturer 12 to locate and/or contact the consumer 24 and assist the consumer 24 with handling the problem. The manufacturer 12 has access to the national registry office 17 so as to be able to accomplish such tasks. The manufacturer 12 may call or send an email 21 to the consumer 24 in a manner as described above.

Thus, this unique counterfeit detection method 8 advantageously allows the consumer 24 to purchase products 10x the authenticity of which are in question and immediately know whether the products 10x are authentic products 10 in a speedy and reliable manner.

It will be appreciated by those skilled in the art that while a counterfeit product detection method 8 has been described in detail herein, the invention is not necessarily so limited and other examples, embodiments, uses, modifications, and departures from the embodiments, examples, uses, and modifications may be made without departing from the counterfeit product detection method 8 and all such embodiments are intended to be within the scope and spirit of the appended claims.

1. A counterfeit detection method comprising the acts of:
providing a manufacturer for producing a product that is not counterfeit;
providing the manufacturer with a manufacturer identification number and wherein the manufacturer creates a sequential serial number for the product that is not counterfeit;
wherein the manufacturer applies the manufacture identification number and the sequential serial number to the product that is not counterfeit;
providing a consumer with a product having its own manufacture identification number and sequential serial number wherein the authenticity of the manufacture identification number and a sequential serial number on the product provided to the consumer is not known; and,
wherein the manufacturer verifies the authenticity of the product provided to the consumer by comparing its manufacturer identification number and the sequential serial number for the product that is not counterfeit with the sequential serial number and manufacturer identification number provided on the product provided to the consumer serial number.

2. The counterfeit detection method according to claim 1 wherein the product provided to the consumer is authentic if the manufacturer identification number and the sequential serial number for the product that is not counterfeit match the sequential serial number and manufacturer identification number appearing on the product provided to the consumer.

3. The counterfeit detection method according to claim 1 wherein the step of creating the sequential serial number is carried out by the manufacturer and the sequential serial number includes utilizing letters except for the letters B, C, D, E, M, N, P, T, V, and Z.

4. The counterfeit detection method according to claim 1 wherein the step of applying the sequential serial number to the product is by at least one of the following methods: laser etching the sequential serial number directly the product; stamping the sequential serial number into or onto the product; sewing a tag having the sequential serial number to the product; and attaching to the product a sticker with the sequential serial number printed thereon.

5. The counterfeit detection method according to claim 1 wherein the manufacture saves the following information pertaining to the product that is not counterfeit including:
the model and model number of the product;
the country of origin of the product; and
the date of manufacture of the product.

6. The counterfeit detection method according to claim 5 wherein the manufacturer uses the information pertaining to the product that is not counterfeit including using the model and model number of the product, the country of origin of the product; and date of manufacture of the product for further verifying whether or not the product provided to the consumer is authentic.

7. The counterfeit detection method according to claim 1 wherein the authenticity of the product provided to the consumer is verified by a retailer at the time the product is sold by the retailer to the consumer.

8. The counterfeit detection method according to claim 7 wherein the step of verifying whether or not the product is counterfeit by the retailer further includes presenting the product to a retailer; allowing the retailer to access a website operated by the manufacturer; entering the identification number of the manufacturer; entering the sequential serial number appearing on the product being purchased by the consumer; receiving a response in the form of an email from the manufacturer as to whether the product is or is not counterfeit; printing the email and providing the printed email to the consumer.

9. The counterfeit detection method according to claim 1 wherein the step of verifying whether or not the product provided to the consumer is counterfeit includes providing the consumer with a personal consumer computer, allowing the consumer to access a website of the manufacturer; inputting the sequential serial number and manufacturer identification number that appear on the product provided to the consumer; and allowing the manufacturer to send a response back to the consumer indicating whether or not the product provided to the consumer is authentic or counterfeit; and wherein the response is in the form of an email send to the consumer by the manufacturer and is printed by the consumer so that the consumer has a printed email pertaining to the authenticity of the product provided to the consumer.

10. The counterfeit detection method according to claim 9 further including returning the product to the retailer that provided the product to the consumer in the event the product is not authentic.

11. The counterfeit detection method according to claim 1 further including the consumer calling the manufacturer and providing the manufacturer with the sequential serial number and the manufacturer identification number appearing on the product provided to the consumer and obtaining a response from the manufacturer regarding whether or not the product is counterfeit.

12. The counterfeit detection method according to claim 1 further including having the consumer obtain a permanent personal identification number in advance of purchasing the product and providing a national registry office for generating the permanent personal identification number and allowing the consumer to register in the national registry office for product warranties and product recalls, such that in the event of a product recall the national registry office alerts the consumer of the product recall.

13. A method for detecting whether a purchased product is counterfeit comprising;
providing a programmed manufacturer general purpose computer having a central processing unit;
providing a sequential serial number data pertaining to a non-counterfeit product, manufacturer identification number data, model and model number data pertaining to the non-counterfeit product, country of origin of the product data pertaining to the non-counterfeit product, and date of manufacture data pertaining to the non-counterfeit product;
storing sequential serial number data pertaining to the non-counterfeit product, manufacturer identification number data, model and model number data pertaining to the non-counterfeit product, country of origin of the product data pertaining to the non-counterfeit product, and date of manufacture data pertaining to the non-counterfeit product a memory component of the programmed manufacturer general purpose computer;
inputting data pertaining to a product purchased by a consumer including sequential serial number data and manufacturer identification number data appearing on the product purchased wherein the authenticity of the product purchased is unknown;
using the central processing unit and comparing the data pertaining to the product purchased including the sequential serial number data and manufacturer identification number to the sequential serial number data and the manufacturer identification number data pertaining to the non-counterfeit product;
using the central processing unit to determine whether the product purchased by the consumer is counterfeit;
providing the programmed manufacturer general purpose computer an interface component and using the central processing unit and using the interface component for generating an output in the form of a screen display and an email indicating whether or not the product purchased is authentic;
displaying the outputs on a display associated with a retailer computer and a display associated with a consumer computer; and,
printing the email indicating whether or not the product purchased by the consumer is authentic.

14. The method for detecting whether purchased product is counterfeit according to claim 13 further including the step of the manufacturer generating the sequential serial number data wherein the sequential serial number data includes utilizing letters except for the letters B, C, D, E, M, N, P, T, V, and Z.

15. The method for detecting whether a purchased product is counterfeit according to claim 13 further including the step of the consumer calling the manufacturer with a phone and providing the manufacturer with the sequential serial number and the manufacturer identification number appearing on the product provided to the consumer and obtaining a response from the manufacturer regarding whether or not the product is counterfeit.

16. A system for determining whether of not a product is counterfeit comprising:
a programmed manufacturer general purpose computer having a central processing unit and a memory component;
storing sequential serial number data pertaining to a non-counterfeit product, manufacturer identification number data, model and model number data pertaining to the non-counterfeit product, country of origin of the product data pertaining to the non-counterfeit product, and date of manufacture data pertaining to the non-counterfeit product in the memory component;
storing sequential serial number data pertaining to a product purchased by a consumer including sequential serial number data and manufacturer identification number data appearing on the product purchased wherein the authenticity of the product purchased is unknown in the memory component;
using the central processing unit and comparing the data pertaining to the product purchased including the sequential serial number data and manufacturer identification number to the sequential serial number data and the manufacturer identification number data pertaining to the non-counterfeit product;
using the central processing unit to determine whether the product purchased by the consumer is counterfeit;
using the central processing unit and generating an output in the form of a screen display and an email indicating whether or not the product purchased is authentic;
an interface component for allowing the programmed manufacturer general purpose computer for allowing the output to be transmitted to a display associated with a retailer computer and a display associated with a consumer computer; and,
wherein the output is an email that is printed indicating whether or not the product purchased by the consumer is authentic.

17. The system for determining whether or not a product is counterfeit according to claim 16 further including using the programmed manufacturer general purpose computer to create the sequential serial number data pertaining to a non-counterfeited product such that the sequential serial number includes letters except for the letters B, C, D, E, M, N, P, T, V, and Z.
